(19) United States
(12) Patent Application Publication
(10) Pub. No.: US 2026/0298674 A1
(43) Pub. Date: Oct. 1, 2026

(54) OPTICAL FIBER SENSING SYSTEM, OPTICAL FIBER SENSING DEVICE, AND BREAKAGE DETECTION METHOD

(71) Applicant: NEC Corporation, Minato-ku, Toky (JP)

(72) Inventors: Tadayuki IWANO, Tokyo (JP); Yukihide YODA, Tokyo (JP)

(73) Assignee: NEC Corporation, Minato-ku, Toky (JP)

(21) Appl. No.: 18/879,313

(22) PCT Filed: Sep. 13, 2022
(86) PCT No.: PCT/JP2022/034145

§ 371 Date: Dec. 27, 2024

(51) Int. Cl. G01D 5/353; G01H 9/00; G08B 29/06; H04B 10/079; H04B 10/25

(52) U.S. Cl. CPC G01D 5/35358; G01H 9/004; G08B 29/06; H04B 10/0791; H04B 10/25

(57) ABSTRACT

An optical fiber sensing system according to the present disclosure includes: an optical fiber (10); a communication unit (21) that transmits pulsed light to the optical fiber (10) and receives an optical signal from the optical fiber (10); a far end detection unit (22) that continuously or periodically detects a far end position of the optical fiber (10) based on the optical signal received from the optical fiber (10); and a breakage detection unit (23) that determines that the optical fiber (10) is broken in a case where a difference between the far end position detected by the far end detection unit (22) and an initial value of the far end position exceeds a predetermined value.

### TECHNICAL FIELD

The present disclosure relates to an optical fiber sensing system, an optical fiber sensing device, and a breakage detection method.

### BACKGROUND ART

In recent years, a technology called optical fiber sensing using an optical fiber as a sensor has attracted attention. The optical fiber sensing is mainly implemented by an optical fiber and an optical fiber sensing device connected to the optical fiber.

The optical fiber sensing device transmits pulsed light to the optical fiber, and receives backscattered light as an optical signal for the pulsed light from the optical fiber. The optical fiber sensing device detects vibration, sound, temperature change, or the like generated in the optical fiber based on the optical signal, and specifies a position where the vibration or the like has been generated.

For example, in a case where the optical fiber is installed in a region or an object in which an abnormality is desired to be detected, the optical fiber sensing device can further detect an abnormality in the object that is being monitored or specify a position where the abnormality is detected based on the detected vibration or the like.

However, in a case where the optical fiber is broken for a certain reason, the optical fiber sensing device is not able to obtain data at a position beyond the breakage location. Therefore, in a case where the optical fiber sensing device has detected an abnormality based on data at a position beyond the breakage location, the optical fiber sensing device is no longer able to detect an abnormality thereafter.

For this reason, a technology for detecting breakage in an optical fiber has recently been proposed.

For example, Patent Literature 1 describes a technology for detecting disconnection such as breakage in an optical fiber if Fresnel reflected light is detected when test light is incident on the optical fiber.

### CITATION LIST

### Patent Literature

Patent Literature 1: Japanese Unexamined Patent Application Publication No. 2001-324358

### SUMMARY OF INVENTION

### Technical Problem

Since the technology described in Patent Literature 1 is a technology in which Fresnel reflected light is detected as described above, it is considered that it is possible to detect a far end (distal end) position of the optical fiber.

However, many optical fibers, particularly sensing optical fibers, originally have free ends at their far ends.

For this reason, it is considered that simply detecting the far end position of the optical fiber, as in the technology described in Patent Literature 1, is not enough to detect breakage in an optical fiber whose far end is a free end.

Therefore, in view of the above-described problem, an object of the present disclosure is to provide an optical fiber sensing system, an optical fiber sensing device, and a breakage detection method capable of detecting breakage in an optical fiber.

### Solution to Problem

An optical fiber sensing system according to an aspect includes:
an optical fiber;
a communication unit configured to transmit pulsed light to the optical fiber and receive an optical signal from the optical fiber;
a far end detection unit configured to continuously or periodically detect a far end position of the optical fiber based on the optical signal received from the optical fiber; and
a breakage detection unit configured to determine that the optical fiber is broken in a case where a difference between the far end position detected by the far end detection unit and an initial value of the far end position exceeds a predetermined value.

An optical fiber sensing device according to an aspect includes:
a communication unit configured to transmit pulsed light to an optical fiber and receive an optical signal from the optical fiber;
a far end detection unit configured to continuously or periodically detect a far end position of the optical fiber based on the optical signal received from the optical fiber; and
a breakage detection unit configured to determine that the optical fiber is broken in a case where a difference between the far end position detected by the far end detection unit and an initial value of the far end position exceeds a predetermined value.

A breakage detection method according to an aspect is a breakage detection method performed by an optical fiber sensing device including:
a communication step of transmitting pulsed light to an optical fiber and receiving an optical signal from the optical fiber;
a far end detection step of continuously or periodically detecting a far end position of the optical fiber based on the optical signal received from the optical fiber; and
a breakage detection step of determining that the optical fiber is broken in a case where a difference between the far end position detected in the far end detection step and an initial value of the far end position exceeds a predetermined value.

### Advantageous Effects of Invention

According to the above-described aspects, it is possible to provide an optical fiber sensing system, an optical fiber sensing device, and a breakage detection method capable of detecting breakage in an optical fiber.

### BRIEF DESCRIPTION OF DRAWINGS

FIG. 1 is a diagram illustrating a configuration example of an optical fiber sensing system according to a first example embodiment.

FIG. 2 is a diagram illustrating an image of an operation example of a far end detection unit and a breakage detection unit according to the first example embodiment.

FIG. 3 is a diagram illustrating an example of a method of detecting a far end position of an optical fiber by a far end detection unit according to the first example embodiment.

FIG. 4 is a diagram illustrating another example of a method of detecting a far end position of an optical fiber by a far end detection unit according to the first example embodiment.

FIG. 5 is a flowchart illustrating an example of a schematic operation flow of the optical fiber sensing system according to the first example embodiment.

FIG. 6 is a diagram illustrating a configuration example of an optical fiber sensing system according to a second example embodiment.

FIG. 7 is a flowchart illustrating an example of a schematic operation flow of the optical fiber sensing system according to the second example embodiment.

FIG. 8 is a block diagram illustrating a hardware configuration example of a computer that implements an optical fiber sensing device according to the first or second example embodiment.

### EXAMPLE EMBODIMENT

Hereinafter, example embodiments of the present disclosure will be described with reference to the drawings. Note that, in the following description and drawings, omission and simplification are made, as appropriate, for clarity of explanation. Furthermore, in the following drawings, the same elements are denoted by the same reference signs, and redundant description will be omitted as necessary. In addition, specific numerical values and the like shown below are merely examples for facilitating understanding of the present disclosure, and the present disclosure is not limited thereto.

### First Example Embodiment

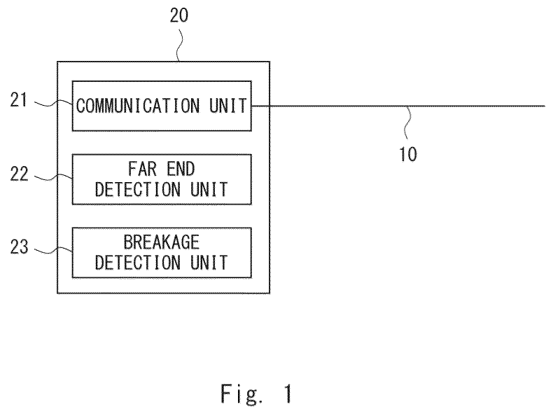

First, a configuration example of an optical fiber sensing system according to a first example embodiment will be described with reference to FIG. 1.

As illustrated in FIG. 1, the optical fiber sensing system according to the first example embodiment includes an optical fiber 10 and an optical fiber sensing device 20.

The optical fiber sensing device 20 is implemented by, for example, a distributed fiber optic sensing (DFOS) apparatus, and includes a communication unit 21, a far end detection unit 22, and a breakage detection unit 23. Note that the communication unit 21, the far end detection unit 22, and the breakage detection unit 23 are not limited to being provided in the same apparatus as in FIG. 1, and may be provided in separate apparatuses. The far end detection unit 22 and the breakage detection unit 23 may be provided on a cloud.

One end of the optical fiber 10 is connected to the communication unit 21 of the optical fiber sensing device 20, and the other end of the optical fiber 10 is a free end. In addition, the optical fiber 10 is installed, for example, in a region or an object in which an abnormality is desired to be detected. In addition, the optical fiber 10 may be installed in the form of an optical fiber cable configured by covering one or more optical fibers 10.

The communication unit 21 transmits pulsed light to the optical fiber 10. Then, as the pulsed light is transmitted to the optical fiber 10, backscattered light is generated. The communication unit 21 receives the backscattered light from the optical fiber 10 as an optical signal.

The far end detection unit 22 continuously or periodically detects a far end position of the optical fiber 10 based on the optical signal received from the optical fiber 10 by the communication unit 21. A method of detecting the far end position of the optical fiber 10 will be described later.

The breakage detection unit 23 holds an initial value of the far end position of the optical fiber 10. In a case where the far end position of the optical fiber 10 is detected by the far end detection unit 22, the breakage detection unit 23 determines whether a difference between the detected far end position and the initial value of the far end position exceeds a predetermined value. If the difference exceeds the predetermined value, the breakage detection unit 23 determines that the optical fiber 10 is broken.

The predetermined value described above held by the breakage detection unit 23 is preferably set in consideration of a detection error of the far end position detected by the far end detection unit 22. In addition, it is assumed that the specific numerical value of the predetermined value described above is, for example, about 1 m, but is not limited thereto.

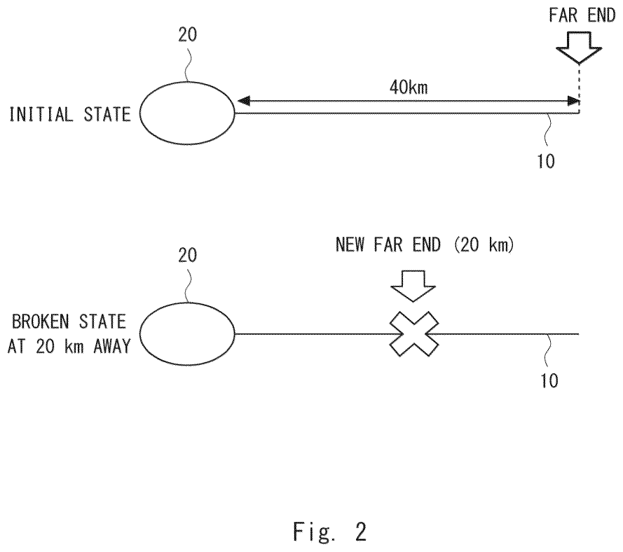

Here, an image of an operation example of the far end detection unit 22 and the breakage detection unit 23 according to the first example embodiment will be described with reference to FIG. 2.

Referring to FIG. 2, it is assumed that, in an initial state, the far end position of the optical fiber 10 is 40 km away from the optical fiber sensing device 20 (the communication unit 21). Therefore, it is assumed that the breakage detection unit 23 holds “40 km” as the initial value of the far end position of the optical fiber 10.

In such an environment, it is assumed that the optical fiber 10 is broken at a position 20 km midway from the optical fiber sensing device 20 (the communication unit 21) for a certain reason. In this case, the far end detection unit 22 detects “20 km” as the far end position of the optical fiber 10 by continuous or periodic detection.

Then, the breakage detection unit 23 calculates “20 km” as a difference between the far end position “20 km” detected by the far end detection unit 22 and the initial value “40 km” of the far end position. The difference “20 km” exceeds the predetermined value assumed to be set to about 1 m as described above. Therefore, the breakage detection unit 23 determines that the optical fiber 10 is broken at a position 20 km midway from the optical fiber sensing device 20 (the communication unit 21).

Here, a method of detecting the far end position of the optical fiber 10 by the far end detection unit 22 will be described in detail. Two methods will be described below.

### (1) First Method

The far end detection unit 22 can specify a position where the optical signal is generated (a distance of the optical fiber 10 from the optical fiber sensing device 20 (the communication unit 21)) based on a time difference between a time when the pulsed light is transmitted to the optical fiber 10 by the communication unit 21 and a time when the optical signal is received from the optical fiber 10 by the communication unit 21.

In addition, in a case where a vibration is generated in the optical fiber 10, the characteristic (e.g., wavelength) of the optical signal transmitted to the optical fiber 10 changes. Therefore, the far end detection unit 22 can detect a vibration generated in the optical fiber 10 and a vibration intensity of the vibration by analyzing the characteristic of the optical signal received by the communication unit 21.

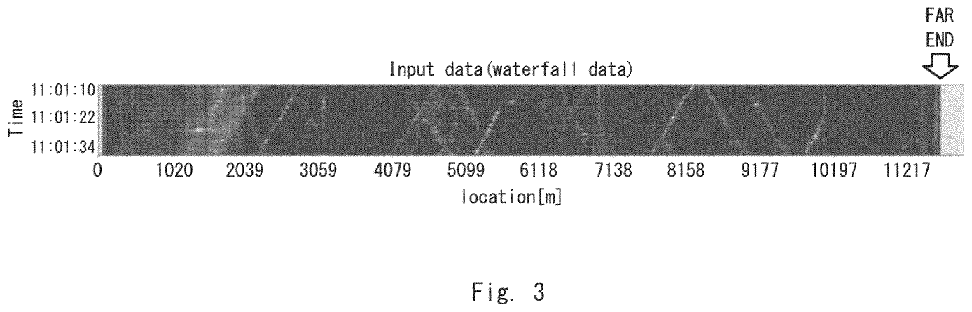

Therefore, in the first method, the far end detection unit 22 acquires so-called waterfall data, which is data as illustrated in FIG. 3. The waterfall data is data expressing, for each distance of the optical fiber 10 from the optical fiber sensing device 20 (the communication unit 21), a time course of vibration intensity within a specified period of time at the distance. More specifically, the waterfall data is data expressing a vibration intensity in color, the vibration intensity being acquired at each distance of the optical fiber 10 at every sampling time interval (e.g., 0.24 seconds) for the specified period of time (e.g., 30 seconds). In FIG. 3, the horizontal axis indicates a distance of the optical fiber 10 from the optical fiber sensing device 20 (the communication unit 21), and the vertical axis indicates a time course of vibration intensity at the distance.

According to the waterfall data as illustrated in FIG. 3, it can be seen that data at a position beyond the far end position of the optical fiber 10 has a large difference in vibration intensity from data at a position in front of the far end position due to influence of random noise generated at the position beyond the far end position.

Therefore, the far end detection unit 22 determines a boundary where the large difference in vibration intensity appears as the far end position of the optical fiber 10.

### (2) Second Method

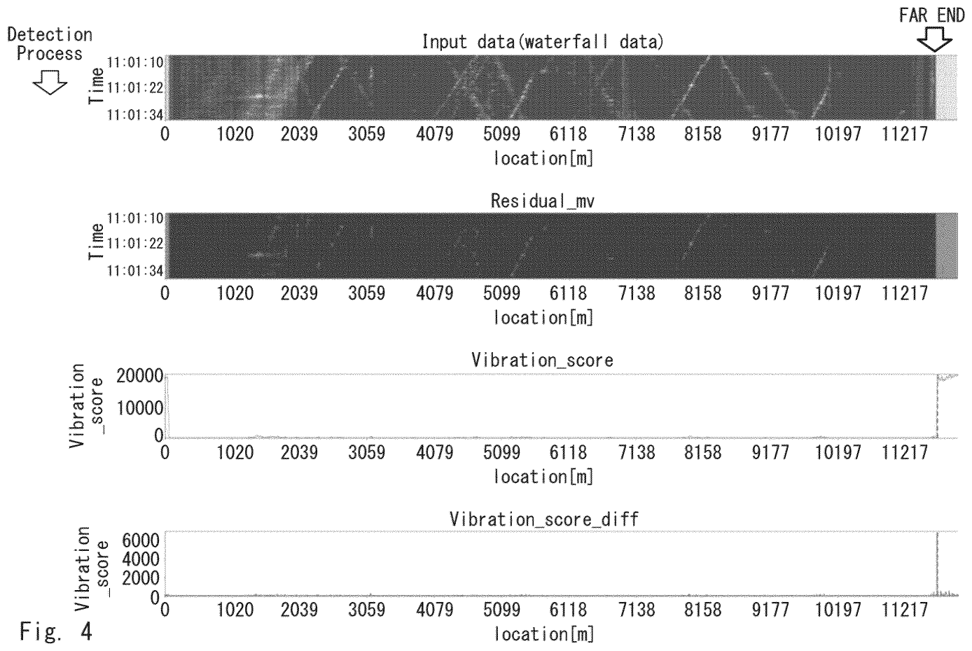

In the second method, first, the far end detection unit 22 acquires waterfall data as illustrated in FIG. 4, similarly to the first method.

Next, after performing convolution processing on the waterfall data, the far end detection unit 22 displays only vibration intensities equal to or higher than the vibration intensity threshold, thereby acquiring residual data (Residual_mv).

Next, for each distance of the optical fiber 10 from the optical fiber sensing device 20 (the communication unit 21), the far end detection unit 22 calculates a vibration score (Vibration_score) at the distance based on the residual data. The vibration score is a score obtained, for each distance of the optical fiber 10, by integrating values of vibration intensities within the specified period of time at the distance. More specifically, the vibration score is a score obtained by integrating values of vibration intensities acquired at each distance of the optical fiber 10 at every sampling time interval (e.g., 0.24 seconds) for the specified period of time (e.g., 30 seconds). For example, in a case where the specified period of time is 30 seconds, the sampling time interval is 0.24 seconds, and vibration intensities within the specified period of time at a certain distance is constant at 100, the vibration score at the distance is 12,500 (=100*(30/0.24)=100*125).

Next, for each distance of the optical fiber 10 from the optical fiber sensing device 20 (the communication unit 21), the far end detection unit 22 calculates a score difference (Vibration_score_diff) between a vibration score at the distance and a vibration score at a distance adjacent to the distance. Note that the adjacent distance is assumed to be a distance adjacent to the optical fiber sensing device 20 (the communication unit 21) side, but is not limited thereto.

Thereafter, the far end detection unit 22 sequentially checks score differences in a positive direction (a right direction in the drawing) from a position where the distance of the optical fiber 10 from the optical fiber sensing device 20 (the communication unit 21) is 0. Then, the far end detection unit 22 determines a position where the score difference exceeds a score difference threshold as the far end position of the optical fiber 10.

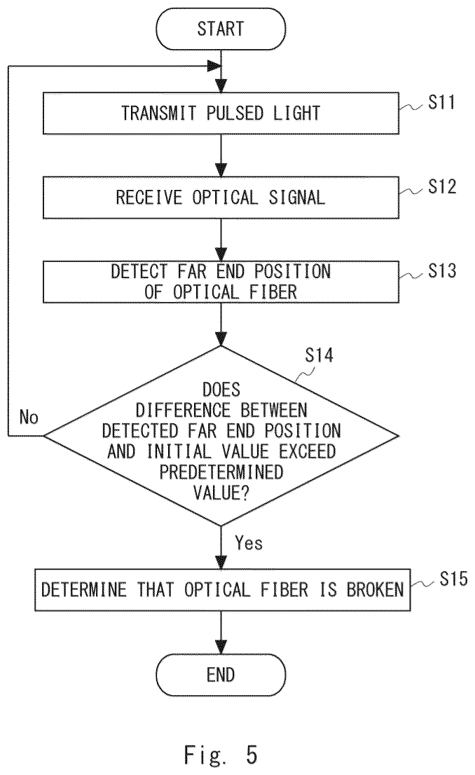

Subsequently, an example of a schematic operation flow of the optical fiber sensing system according to the first example embodiment will be described with reference to FIG. 5.

As illustrated in FIG. 5, at a timing when the far end position of the optical fiber 10 is continuously or periodically detected, the communication unit 21 first transmits pulsed light to the optical fiber 10 (step S11), and receives backscattered light for the pulsed light from the optical fiber 10 as an optical signal (step S12).

Next, the far end detection unit 22 detects a far end position of the optical fiber 10 based on the optical signal received from the optical fiber 10 by the communication unit 21 (step S13). This detection may be performed using the first method or the second method described above.

Next, the breakage detection unit 23 determines whether a difference between the far end position detected by the far end detection unit 22 and an initial value of the far end position exceeds a predetermined value (step S14).

In step S14, in a case where the difference described above is equal to or smaller than the predetermined value (No in step S14), the breakage detection unit 23 determines that the optical fiber 10 is not broken, and the process returns to step S11. The process of step S11 is started at a time point that is a next timing when the far end position of the optical fiber 10 is detected. However, the present invention is not limited thereto, and transmission of pulsed light and reception of optical signal may be continuously performed thereafter, and in a case where No in step S14, the process may return to step S13.

On the other hand, in step S14, in a case where the difference described above exceeds the predetermined value (Yes in step S14), the breakage detection unit 23 determines that the optical fiber 10 is broken (step S15), and ends the process.

As described above, according to the first example embodiment, the communication unit 21 transmits pulsed light to the optical fiber 10, and receives backscattered light as an optical signal for the pulsed light from the optical fiber 10. The far end detection unit 22 detects a far end position of the optical fiber 10 based on the optical signal. The breakage detection unit 23 determines that the optical fiber 10 is broken in a case where a difference between the detected far end position and an initial value of the far end position exceeds a predetermined value. As a result, the breakage of the optical fiber 10 can be detected. In particular, breakage can also be detected in the optical fiber 10 whose far end is a free end.

### Second Example Embodiment

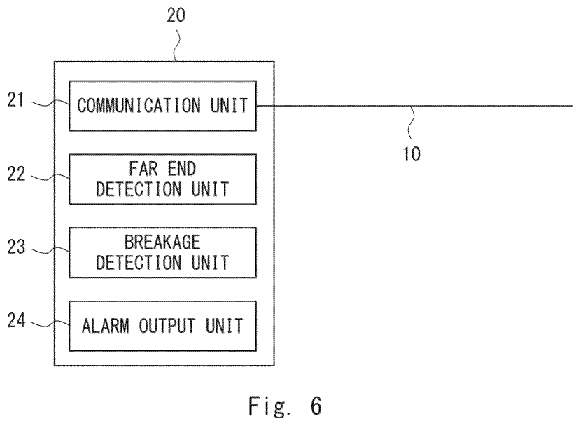

Next, a configuration example of an optical fiber sensing system according to a second example embodiment will be described with reference to FIG. 6.

As illustrated in FIG. 6, the optical fiber sensing system according to the second example embodiment is different from the configuration of FIG. 1 according to the first example embodiment described above in that the optical fiber sensing device 20 includes an alarm output unit 24.

The alarm output unit 24 outputs an alarm in a case where the breakage detection unit 23 determines that the optical fiber 10 is broken. For example, the alarm may be output from the alarm output unit 24 by displaying a screen such as a graphical user interface (GUI) screen indicating that the optical fiber 10 is broken on a display, a monitor, or the like (not illustrated). In addition, the alarm may be output by outputting a voice message indicating that the optical fiber 10 is broken from a speaker (not illustrated).

In the first example embodiment described above, in a case where it is determined that the optical fiber 10 is broken, the process ends. On the other hand, in the second example embodiment, it is continuously detected whether the optical fiber 10 is broken while updating the initial value of the far end position of the optical fiber 10.

Therefore, after determining whether the optical fiber 10 is broken, the breakage detection unit 23 updates the initial value of the far end position of the optical fiber 10 with the value of the far end position detected by the far end detection unit 22, regardless of whether it is determined that the optical fiber 10 is broken.

In a case where the far end position of the optical fiber 10 is detected by the far end detection unit 22 after the initial value of the far end position of the optical fiber 10 is updated, the breakage detection unit 23 determines whether the optical fiber 10 is broken based on whether a difference between the detected far end position and the updated initial value of the far end position exceeds the predetermined value.

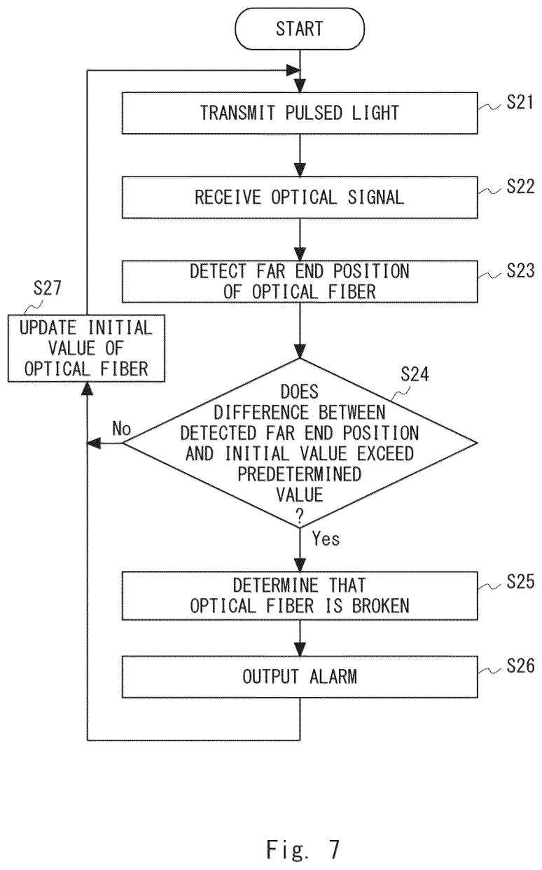

Subsequently, an example of a schematic operation flow of the optical fiber sensing system according to the second example embodiment will be described with reference to FIG. 7.

As illustrated in FIG. 7, first, the processes of steps S21 to S24 that are similar to steps S11 to S14 in FIG. 5 according to the first example embodiment described above are performed.

In step S24, in a case where the difference between the far end position detected by the far end detection unit 22 and the initial value of the far end position is equal to or smaller than the predetermined value (No in step S24), the breakage detection unit 23 determines that the optical fiber 10 is not broken, and then updates the initial value of the far end position of the optical fiber 10 with the value of the far end position detected by the far end detection unit 22 (step S27). Thereafter, the process returns to step S21.

On the other hand, in a case where the difference described above exceeds the predetermined value in step S24 (Yes in step S24), the breakage detection unit 23 determines that the optical fiber 10 is broken (step S25), and the alarm output unit 24 outputs an alarm (step S26). Thereafter, in step S27, the breakage detection unit 23 updates the initial value of the far end position of the optical fiber 10, and the process returns to step S21.

In a case where the process returns to step S21, the process of step S21 is started at a time point that is a next timing when the far end position of the optical fiber 10 is detected. However, the present invention is not limited thereto, and transmission of pulsed light and reception of optical signal may be continuously performed thereafter, and in a case where the process of step S27 is completed, the process may return to step S23.

As described above, according to the second example embodiment, the alarm output unit 24 outputs an alarm in a case where the breakage detection unit 23 determines that the optical fiber 10 is broken. As a result, it is possible to notify an external user (e.g., an administrator or the like who manages the optical fiber 10) that the optical fiber 10 is broken.

According to the second example embodiment, after determining whether the optical fiber 10 is broken, the breakage detection unit 23 updates the initial value of the far end position of the optical fiber 10 with the value of the far end position detected by the far end detection unit 22. After this update, in a case where the far end position of the optical fiber 10 is detected by the far end detection unit 22, the breakage detection unit 23 determines whether the optical fiber 10 is broken based on whether a difference between the detected far end position and the updated initial value of the far end position exceeds the predetermined value. As a result, the breakage of the optical fiber 10 can be continuously detected.

### Hardware Configuration of Optical Fiber Sensing Device According to Example Embodiment

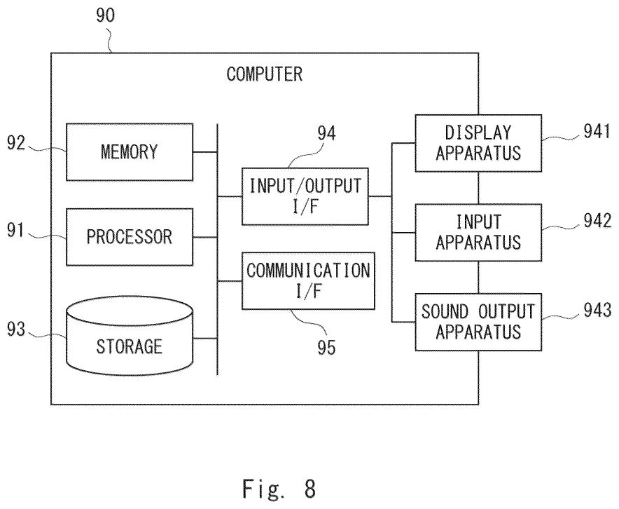

Next, a hardware configuration example of a computer 90 that implements the optical fiber sensing devices 20 according to the first or second example embodiment described above will be described with reference to FIG. 8.

As illustrated in FIG. 9, the computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected to each other by a data transmission line for transmitting and receiving data.

The processor 91 is, for example, an arithmetic processing apparatus such as a central processing unit (CPU) or a graphics processing unit (GPU). The memory 92 is, for example, a memory such as a random access memory (RAM) or a read only memory (ROM). The storage 93 is, for example, a storage apparatus such as a hard disk drive (HDD), a solid state drive (SSD), or a memory card. Furthermore, the storage 93 may be a memory such as a RAM or a ROM.

A program is stored in the storage 93. This program includes a group of commands (or software code) for causing the computer 90 to execute one or more functions of the optical fiber sensing device 20 described above in a case where read by the computer. The components in the optical fiber sensing device 20 described above may be implemented by the processor 91 reading and executing the program stored in the storage 93. In addition, the storage and holding function of the optical fiber sensing device 20 described above may be implemented by the memory 92 or the storage 93.

Further, the above-described program may be stored in a non-transitory computer-readable medium or a tangible storage medium. As an example and not by way of limitation, the computer-readable medium or the tangible storage medium includes a RAM, a ROM, a flash memory, an SSD or any other memory technology, a compact disc (CD)-ROM, a digital versatile disc (DVD), a Blu-ray (registered trademark) disk or any other optical disk storage, a magnetic cassette, a magnetic tape, a magnetic disk storage or any other magnetic storage device. The program may be transmitted on a transitory computer-readable medium or a communication medium. As an example and not by way of limitation, the transitory computer-readable medium or the communication medium includes an electrical signal, an optical signal, an acoustic signal, or any other form of propagation signal.

The input/output interface 94 is connected to a display apparatus 941, an input apparatus 942, a sound output apparatus 943, and the like. The display apparatus 941 is an apparatus that displays a screen corresponding to depiction data processed by the processor 91, such as a liquid crystal display (LCD), a cathode ray tube (CRT) display, or a monitor. The input apparatus 942 is an apparatus that receives an operation input of an operator, and is, for example, a keyboard, a mouse, a touch sensor, or the like. The display apparatus 941 and the input apparatus 942 may be integrated, and may be implemented as a touch panel. The sound output apparatus 943 is an apparatus that acoustically outputs a sound that corresponds to acoustic data processed by the processor 91, such as a speaker.

The communication interface 95 transmits or receives data to and from an external apparatus. For example, the communication interface 95 communicates with an external apparatus via a wired communication path or a wireless communication path.

The present disclosure has been described above with reference to the example embodiments, but the present disclosure is not limited to the example embodiments described above. Various modifications that can be understood by those skilled in the art can be made to the configurations and details of the present disclosure within the scope of the present disclosure.

For example, some or all of the above-described example embodiments may be described as in the following supplementary notes, but are not limited thereto.

### Supplementary Note 1

An optical fiber sensing system, including:
an optical fiber;
a communication unit configured to transmit pulsed light to the optical fiber and receive an optical signal from the optical fiber;
a far end detection unit configured to continuously or periodically detect a far end position of the optical fiber based on the optical signal received from the optical fiber; and
a breakage detection unit configured to determine that the optical fiber is broken in a case where a difference between the far end position detected by the far end detection unit and an initial value of the far end position exceeds a predetermined value.

### Supplementary Note 2

The optical fiber sensing system according to supplementary note 1, in which after determining whether the optical fiber is broken, the breakage detection unit updates the initial value of the far end position with a value of the far end position detected by the far end detection unit.

### Supplementary Note 3

The optical fiber sensing system according to supplementary note 2, in which in a case where the far end position is detected by the far end detection unit after updating the initial value of the far end position, the breakage detection unit determines whether the optical fiber is broken depending on whether a difference between the detected far end position and the updated initial value of the far end position exceeds the predetermined value.

### Supplementary Note 4

The optical fiber sensing system according to supplementary note 1, in which the far end detection unit is configured to:
acquire data expressing, for each distance of the optical fiber from the communication unit, a time course of vibration intensity within a specified period of time at the distance based on the optical signal received from the optical fiber; and
detect the far end position of the optical fiber based on the data.

### Supplementary Note 5

The optical fiber sensing system according to supplementary note 1, in which the far end detection unit is configured to:
calculate a score, for each distance of the optical fiber from the communication unit, by integrating values of vibration intensities within a specified period of time at the distance based on the optical signal received from the optical fiber;
calculate, for each distance of the optical fiber from the communication unit, a score difference between a score at the distance and a score at a distance adjacent to the distance; and
detect the far end position of the optical fiber based on the score difference.

### Supplementary Note 6

The optical fiber sensing system according to supplementary note 1, further including an alarm output unit configured to output an alarm in a case where the breakage detection unit determines that the optical fiber is broken.

### Supplementary Note 7

An optical fiber sensing device including:
a communication unit configured to transmit pulsed light to an optical fiber and receive an optical signal from the optical fiber;
a far end detection unit configured to continuously or periodically detect a far end position of the optical fiber based on the optical signal received from the optical fiber; and
a breakage detection unit configured to determine that the optical fiber is broken in a case where a difference between the far end position detected by the far end detection unit and an initial value of the far end position exceeds a predetermined value.

### Supplementary Note 8

The optical fiber sensing device according to supplementary note 7, in which after determining whether the optical fiber is broken, the breakage detection unit updates the initial value of the far end position with a value of the far end position detected by the far end detection unit.

### Supplementary Note 9

The optical fiber sensing device according to supplementary note 8, in which in a case where the far end position is detected by the far end detection unit after updating the initial value of the far end position, the breakage detection unit determines whether the optical fiber is broken depending on whether a difference between the detected far end position and the updated initial value of the far end position exceeds the predetermined value.

### Supplementary Note 10

The optical fiber sensing device according to supplementary note 7, in which the far end detection unit is configured to:
acquire data expressing, for each distance of the optical fiber from the communication unit, a time course of vibration intensity within a specified period of time at the distance based on the optical signal received from the optical fiber; and
detect the far end position of the optical fiber based on the data.

### Supplementary Note 11

The optical fiber sensing device according to supplementary note 7, in which the far end detection unit is configured to:
calculate a score, for each distance of the optical fiber from the communication unit, by integrating values of vibration intensities within a specified period of time at the distance based on the optical signal received from the optical fiber;
calculate, for each distance of the optical fiber from the communication unit, a score difference between a score at the distance and a score at a distance adjacent to the distance; and
detect the far end position of the optical fiber based on the score difference.

### Supplementary Note 12

The optical fiber sensing device according to supplementary note 7, further including an alarm output unit configured to output an alarm in a case where the breakage detection unit determines that the optical fiber is broken.

### Supplementary Note 13

A breakage detection method performed by an optical fiber sensing device, the breakage detection method including:
a communication step of transmitting pulsed light to an optical fiber and receiving an optical signal from the optical fiber;
a far end detection step of continuously or periodically detecting a far end position of the optical fiber based on the optical signal received from the optical fiber; and
a breakage detection step of determining that the optical fiber is broken in a case where a difference between the far end position detected in the far end detection step and an initial value of the far end position exceeds a predetermined value.

### Supplementary Note 14

The breakage detection method according to supplementary note 13, in which in the breakage detection step, after it is determined whether the optical fiber is broken, the initial value of the far end position is updated with a value of the far end position detected in the far end detection step.

### Supplementary Note 15

The breakage detection method according to supplementary note 14, in which in a case where the far end position is detected in the far end detection step after updating the initial value of the far end position, it is determined in the breakage detection step whether the optical fiber is broken depending on whether a difference between the detected far end position and the updated initial value of the far end position exceeds the predetermined value.

### Supplementary Note 16

The breakage detection method according to supplementary note 13, in which in the far end detection step:
data expressing, for each distance of the optical fiber from the communication unit, a time course of vibration intensity within a specified period of time at the distance is acquired based on the optical signal received from the optical fiber; and
the far end position of the optical fiber is detected based on the data.

### Supplementary Note 17

The breakage detection method according to supplementary note 13, in which in the far end detection step:
for each distance of the optical fiber from the communication unit, a score is calculated by integrating values of vibration intensities within a specified period of time at the distance based on the optical signal received from the optical fiber;
for each distance of the optical fiber from the communication unit, a score difference between a score at the distance and a score at a distance adjacent to the distance is calculated; and
the far end position of the optical fiber is detected based on the score difference.

### Supplementary Note 18

The breakage detection method according to supplementary note 13, further including an alarm output step of outputting an alarm in a case where it is determined in the breakage detection step that the optical fiber is broken.

### REFERENCE SIGNS LIST

10 OPTICAL FIBER
20 OPTICAL FIBER SENSING DEVICE
21 COMMUNICATION UNIT
22 FAR END DETECTION UNIT
23 BREAKAGE DETECTION UNIT
24 ALARM OUTPUT UNIT
90 COMPUTER
91 PROCESSOR
92 MEMORY
93 STORAGE
94 INPUT/OUTPUT INTERFACE
941 DISPLAY APPARATUS
942 INPUT APPARATUS
943 SOUND OUTPUT APPARATUS
95 COMMUNICATION INTERFACE

What is claimed is:

1. An optical fiber sensing system, comprising:
an optical fiber;
at least one memory storing instructions, and
at least one processor configured to execute the instructions to;
transmit pulsed light to the optical fiber and receive an optical signal from the optical fiber;
continuously or periodically detect a far end position of the optical fiber based on the optical signal received from the optical fiber; and
determine that the optical fiber is broken in a case where a difference between the detected far end position and an initial value of the far end position exceeds a predetermined value.

2. The optical fiber sensing system according to claim 1, wherein after determining whether the optical fiber is broken, the at least one processor is further configured to execute the instructions to update the initial value of the far end position with a value of the detected far end position.

3. The optical fiber sensing system according to claim 2, wherein in a case where the far end position is detected after updating the initial value of the far end position, the at least one processor is further configured to execute the instructions to determine whether the optical fiber is broken depending on whether a difference between the detected far end position and the updated initial value of the far end position exceeds the predetermined value.

4. The optical fiber sensing system according to claim 1, wherein the at least one processor is further configured to execute the instructions to:
acquire data expressing, for each distance of the optical fiber from an optical fiber sensing device, a time course of vibration intensity within a specified period of time at the distance based on the optical signal received from the optical fiber; and
detect the far end position of the optical fiber based on the data.

5. The optical fiber sensing system according to claim 1, wherein the at least one processor is further configured to execute the instructions to:
calculate a score, for each distance of the optical fiber from an optical fiber sensing device, by integrating values of vibration intensities within a specified period of time at the distance based on the optical signal received from the optical fiber;
calculate, for each distance of the optical fiber from the optical fiber sensing device, a score difference between a score at the distance and a score at a distance adjacent to the distance; and
detect the far end position of the optical fiber based on the score difference.

6. The optical fiber sensing system according to claim 1, wherein the at least one processor is further configured to execute the instructions to output an alarm in a case where it is determined that the optical fiber is broken.

7. An optical fiber sensing device comprising:
at least one memory storing instructions, and
at least one processor configured to execute the instructions to;
transmit pulsed light to an optical fiber and receive an optical signal from the optical fiber;
continuously or periodically detect a far end position of the optical fiber based on the optical signal received from the optical fiber; and
determine that the optical fiber is broken in a case where a difference between the detected far end position and an initial value of the far end position exceeds a predetermined value.

8. The optical fiber sensing device according to claim 7, wherein after determining whether the optical fiber is broken, the at least one processor is further configured to execute the instructions to update the initial value of the far end position with a value of the detected far end position.

9. The optical fiber sensing device according to claim 8, wherein in a case where the far end position is detected after updating the initial value of the far end position, the at least one processor is further configured to execute the instructions to determine whether the optical fiber is broken depending on whether a difference between the detected far end position and the updated initial value of the far end position exceeds the predetermined value.

10. The optical fiber sensing device according to claim 7, wherein the at least one processor is further configured to execute the instructions to:
acquire data expressing, for each distance of the optical fiber from the optical fiber sensing device, a time course of vibration intensity within a specified period of time at the distance based on the optical signal received from the optical fiber; and
detect the far end position of the optical fiber based on the data.

11. The optical fiber sensing device according to claim 7, wherein the at least one processor is further configured to execute the instructions to:
calculate a score, for each distance of the optical fiber from the optical fiber sensing device, by integrating values of vibration intensities within a specified period of time at the distance based on the optical signal received from the optical fiber;
calculate, for each distance of the optical fiber from the optical fiber sensing device, a score difference between a score at the distance and a score at a distance adjacent to the distance; and
detect the far end position of the optical fiber based on the score difference.

12. The optical fiber sensing device according to claim 7, wherein the at least one processor is further configured to execute the instructions to output an alarm in a case where it is determined that the optical fiber is broken.

13. A breakage detection method performed by an optical fiber sensing device, the breakage detection method comprising:
a communication step of transmitting pulsed light to an optical fiber and receiving an optical signal from the optical fiber;
a far end detection step of continuously or periodically detecting a far end position of the optical fiber based on the optical signal received from the optical fiber; and
a breakage detection step of determining that the optical fiber is broken in a case where a difference between the far end position detected in the far end detection step and an initial value of the far end position exceeds a predetermined value.

14. The breakage detection method according to claim 13, wherein in the breakage detection step, after it is determined whether the optical fiber is broken, the initial value of the far end position is updated with a value of the far end position detected in the far end detection step.

15. The breakage detection method according to claim 14, wherein in a case where the far end position is detected in the far end detection step after updating the initial value of the far end position, it is determined in the breakage detection step whether the optical fiber is broken depending on whether a difference between the detected far end position and the updated initial value of the far end position exceeds the predetermined value.

16. The breakage detection method according to claim 13, wherein in the far end detection step:
data expressing, for each distance of the optical fiber from the optical fiber sensing device, a time course of vibration intensity within a specified period of time at the distance is acquired based on the optical signal received from the optical fiber; and
the far end position of the optical fiber is detected based on the data.

17. The breakage detection method according to claim 13, wherein in the far end detection step:
for each distance of the optical fiber from the optical fiber sensing device, a score is calculated by integrating values of vibration intensities within a specified period of time at the distance based on the optical signal received from the optical fiber;
for each distance of the optical fiber from the optical fiber sensing device, a score difference between a score at the distance and a score at a distance adjacent to the distance is calculated; and
the far end position of the optical fiber is detected based on the score difference.

18. The breakage detection method according to claim 13, further comprising an alarm output step of outputting an alarm in a case where it is determined in the breakage detection step that the optical fiber is broken.
